(19) United States
(12) Patent Application Publication
(10) Pub. No.: US 2026/0277705 A1
(43) Pub. Date: Sep. 17, 2026

(54) Condition-Responsive Dynamically Reconfigurable Spatial Topology System for Persistent Multiplayer Virtual Environments

(71) Applicants: Keaton Casey Martinez, Redlands, CA (US); Taylor Todd Martinez, Nashville, TN (US)

(72) Inventors: Keaton Casey Martinez, Redlands, CA (US); Taylor Todd Martinez, Nashville, TN (US)

(21) Appl. No.: 19/564,201

(22) Filed: Mar. 12, 2026

Related U.S. Application Data
(60) Provisional application No. 63/771,583, filed on Mar. 13, 2025.

(51) Int. Cl. G06F 9/50

(52) U.S. Cl. CPC G06F 9/5088

(57) ABSTRACT

A condition-responsive dynamically reconfigurable spatial topology system for persistent multiplayer virtual environments is disclosed. A plurality of computational instances each execute a respective spatial region. Operational metrics are monitored. A topology data structure stored in memory is modified by adding or removing nodes corresponding to spatial regions in response to expansion and contraction conditions. User session state is migrated between spatial simulation processes while preserving persistent continuity. The system dynamically reconfigures distributed spatial topology to improve resource utilization and eliminate static shard fragmentation.

### CROSS-REFERENCE TO RELATED APPLICATIONS

This application claims the benefit of U.S. Provisional Patent Application No. 63/771,583, filed Mar. 13, 2025, the entirety of which is incorporated herein by reference.

### FIELD OF THE INVENTION

The present disclosure relates generally to distributed computing systems for multiplayer virtual environments and, more particularly, to dynamically reconfigurable spatial server topologies for persistent multiplayer environments that expand and contract in response to runtime operational conditions while preserving logical continuity across spatial regions.

### BACKGROUND OF THE INVENTION

Multiplayer virtual environments have traditionally relied on static server architectures in which a fixed number of computational instances execute predefined world segments or isolated game instances. Common approaches include server sharding, match-based instancing, and static regional partitioning.

In static sharding systems, users are divided among independent server shards, each shard maintaining its own isolated world state. While this approach distributes computational load, it fragments the user base across disconnected environments and limits interaction to users within the same shard.

In match-based instancing systems, sessions are created for a limited number of participants and terminated after session completion. Such systems do not maintain persistent spatial continuity across sessions and do not dynamically reconfigure the spatial topology of the world.

Other scaling techniques replicate server infrastructure or rebalance computational load. However, these approaches generally do not modify the structural topology of the virtual world itself during operation. The spatial configuration remains static even if compute allocation changes.

These limitations produce several technical deficiencies, including over-provisioning of computational resources during periods of low user activity, under-provisioning during peak activity, fragmentation of users across separate instances, inability to dynamically reshape world connectivity in response to runtime conditions, and inefficient load balancing across distributed simulation processes.

Furthermore, existing systems do not dynamically add and remove spatial regions of a persistent multiplayer environment while maintaining seamless migration of user session state across computational boundaries.

There exists a need for a distributed computing architecture capable of dynamically expanding and contracting the spatial topology of a persistent multiplayer environment in response to runtime operational conditions, while preserving logical continuity of user state and shared world context.

### SUMMARY OF THE INVENTION

In one embodiment, a condition-responsive dynamically reconfigurable spatial topology system for persistent multiplayer virtual environments is disclosed.

The system comprises a plurality of computational instances, each executing a respective spatial region of a persistent multiplayer virtual environment.

A condition monitor evaluates one or more operational metrics associated with execution of the spatial regions. Operational metrics may include, but are not limited to, active user population, user density, compute utilization, memory consumption, network latency, throughput, engagement metrics, or other measurable runtime system conditions.

A topology controller modifies a topology data structure stored in memory. The topology data structure comprises a graph including nodes representing spatial regions and edges representing connectivity relationships among spatial regions.

When one or more expansion conditions are satisfied, the topology controller adds one or more nodes to the topology data structure and instantiates corresponding spatial simulation processes on additional computational instances. Newly instantiated regions are immediately logically connected to at least one existing region and become accessible for user migration.

When one or more contraction conditions are satisfied, the topology controller removes one or more nodes from the topology data structure and designates corresponding spatial simulation processes for termination. Regions selected for decommissioning may be non-adjacent and may be selected based on topological position, instantiation order, boundary status, or other criteria.

A migration controller transfers execution state of user session data structures between spatial simulation processes in accordance with connectivity relationships defined by the topology data structure. Persistent user state is preserved across region transitions to maintain logical continuity of the persistent multiplayer environment.

In certain embodiments, each spatial region may enforce a capacity threshold, restrict inbound migration when thresholds are satisfied, and re-enable migration when conditions change.

In certain embodiments, contraction may include advancing a boundary within a region to induce migration of user sessions prior to decommissioning.

In certain embodiments, a dynamic topology representation may be presented to users reflecting currently active spatial regions and connectivity relationships.

The disclosed system modifies spatial topology at runtime by altering graph structures in memory and instantiating or terminating distributed simulation processes, thereby improving distributed resource utilization and eliminating static shard fragmentation.

The invention is not limited to specific region shapes, grid configurations, server technologies, programming frameworks, or virtual environment genres.

### BRIEF DESCRIPTION OF THE DRAWINGS

FIG. 1 illustrates a block diagram of a distributed computing architecture for a condition-responsive dynamically reconfigurable spatial topology system, including computational instances, a condition monitor, a topology controller, a migration controller, and a topology data structure stored in memory.

FIG. 2 illustrates an example topology data structure represented as a graph comprising nodes corresponding to spatial regions and edges corresponding to connectivity relationships governing user migration pathways.

FIG. 3 illustrates an example expansion operation in which one or more additional spatial regions are instantiated, corresponding nodes are added to the topology data structure, and new edges are created between the newly instantiated region and one or more existing regions.

FIG. 4 illustrates an example contraction operation in which one or more spatial regions are designated for decommissioning, corresponding nodes are removed from the topology data structure, and associated connectivity edges are eliminated, including embodiments in which multiple non-adjacent regions are removed.

FIG. 5 illustrates an example user migration process in which the execution state associated with a user session data structure is transferred from a first spatial simulation process to a second spatial simulation process.

FIG. 6 illustrates an example capacity gating embodiment in which a spatial region reaches a threshold condition and inbound migration is restricted while alternative routing directs user sessions to other spatial regions.

FIG. 7 illustrates an example forced contraction embodiment in which an advancing boundary within a spatial region induces migration of user sessions to adjacent regions prior to decommissioning.

FIG. 8 illustrates an example dynamic topology representation presented to a user reflecting currently active spatial regions and updating in response to expansion and contraction operations.

### DETAILED DESCRIPTION

Reference will now be made in detail to embodiments of the invention, examples of which are illustrated in the accompanying drawings. Like reference numerals refer to like elements throughout the drawings.

### 1. Overview of Distributed Spatial Topology Architecture

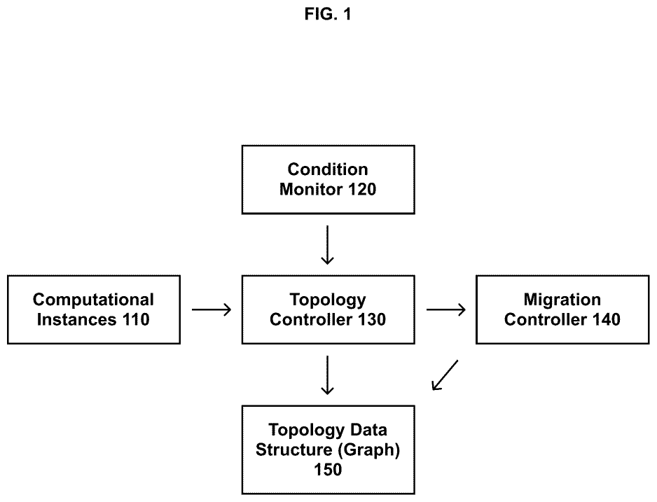

The disclosed system provides a distributed computing architecture for dynamically modifying the spatial topology of a persistent multiplayer virtual environment during runtime, as illustrated in FIG. 1.

Unlike conventional architectures in which world segmentation is static, the present system dynamically adds and removes spatial regions while preserving logical continuity across distributed computational instances.

Spatial regions are executed as spatial simulation processes across multiple networked computational instances. Each computational instance may comprise a physical server, virtual machine, containerized process, cloud instance, or other computing device capable of executing simulation logic.

The system operates by monitoring operational metrics and modifying a topology data structure 150 that governs connectivity among spatial simulation processes. As shown in FIG. 1, the system may include computational instances 110, a condition monitor 120, a topology controller 130, and a migration controller 140.

### 2. Spatial Regions and Simulation Processes

Each spatial region 161-166 corresponds to a portion of the persistent multiplayer environment executed by a spatial simulation process.

A spatial region may represent any bounded area within a virtual environment and is not limited to any specific geometric configuration.

Regions may be, for example, square regions, rectangular regions, polygonal regions, circular regions, irregular regions, and three-dimensional volumetric segments.

Regions may connect to adjacent regions along shared boundaries or via defined migration pathways.

The invention does not require grid-based topology, linear chaining, or fixed adjacency patterns.

### 3. Topology Data Structure

Connectivity among spatial regions is represented by a topology data structure stored in memory.

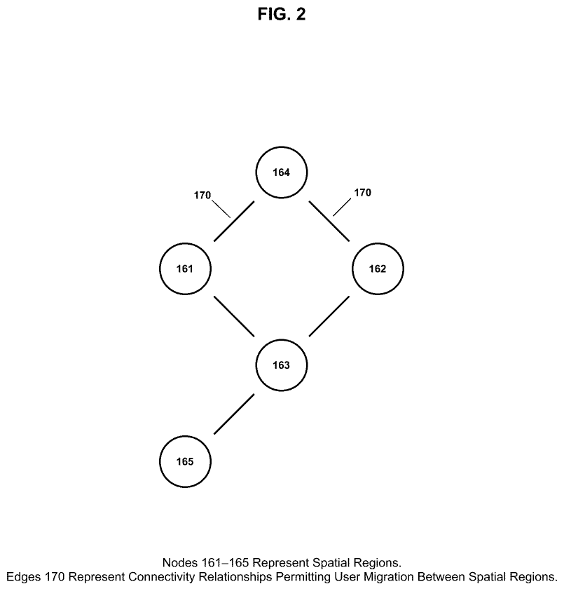

In certain embodiments, the topology data structure 150 comprises a graph data structure including nodes 161-166 representing spatial regions and edges 170 representing connectivity relationships among regions, as illustrated in FIG. 2.

Each node may store metadata including a region identifier, an associated computational instance, current operational metrics, capacity thresholds, and state flags including active, gated, and decommissioning states.

Edges define permissible migration relationships between spatial simulation processes.

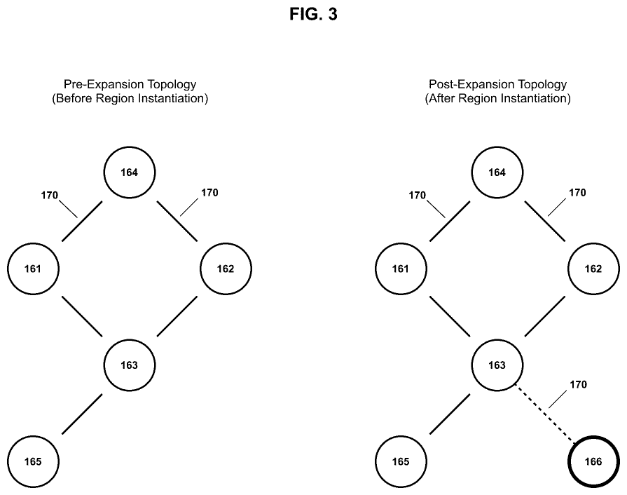

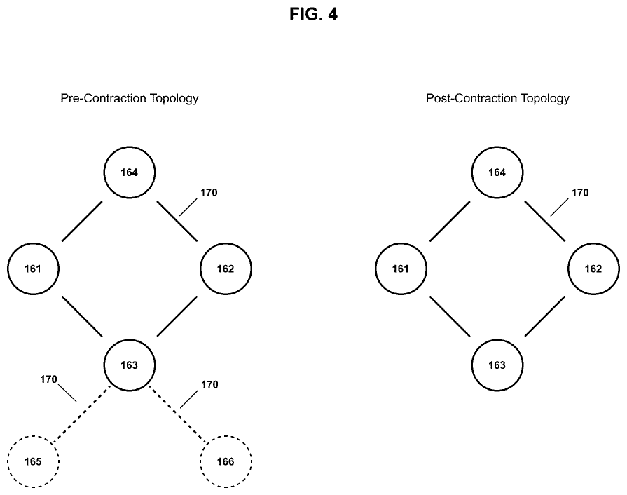

The topology controller 130 modifies this graph data structure during expansion and contraction operations, as illustrated in FIGS. 3 and 4.

Graph modification operations may include adding nodes, removing nodes, adding edges, removing edges, updating node attributes, and updating edge attributes.

This graph modification governs allowable migration pathways and defines the active topology of the virtual environment.

### 4. Condition Monitoring and Threshold Evaluation

A condition monitor evaluates one or more operational metrics across the distributed system.

Operational metrics may include global active user population, regional user density, CPU utilization, memory usage, network bandwidth utilization, latency measurements, throughput metrics, engagement or session duration metrics, queue lengths, and other measurable runtime conditions.

Expansion and contraction conditions may be defined as threshold comparisons, proportional relationships, predictive models, or rule-based evaluations.

In certain embodiments, expansion may occur when a global population exceeds a defined upper threshold.

In certain embodiments, contraction may occur when global population falls below a defined lower threshold.

In other embodiments, expansion and contraction may be driven by compute utilization or other resource metrics.

### 5. Expansion Operation

When one or more expansion conditions are satisfied, the topology controller performs a sequence of operations including allocating or provisioning an additional computational instance, instantiating a new spatial simulation process on the additional computational instance, adding a corresponding node to the topology data structure, adding one or more edges connecting the new node to one or more existing nodes, and marking the new region as active and migration-accessible.

Newly instantiated regions are immediately logically connected to at least one existing region.

In certain embodiments, newly instantiated regions may connect to multiple existing regions simultaneously.

This allows insertion into an existing topology graph rather than strictly appending to a linear chain.

Expansion may occur incrementally or in multi-region batches depending on the magnitude of the triggering condition.

### 6. Capacity Gating and Routing

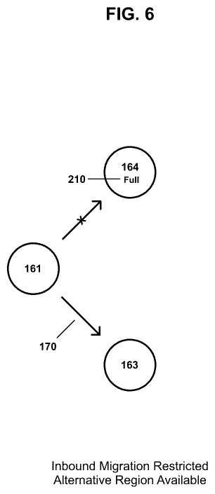

Each spatial region 161-166 may be associated with a capacity threshold. When a region reaches or exceeds a capacity threshold 210, inbound migration may be restricted and user sessions may be redirected to alternative regions via connectivity edges 170, as illustrated in FIG. 6.

When population decreases below the capacity threshold, inbound migration may be re-enabled and edge attributes may be restored to an active state.

Routing logic may select a target region based on factors including lowest population, lowest utilization, geographic proximity, latency metrics, and predictive balancing models.

Capacity gating improves load balancing and prevents over-saturation of individual spatial simulation processes.

### 7. User Migration Architecture

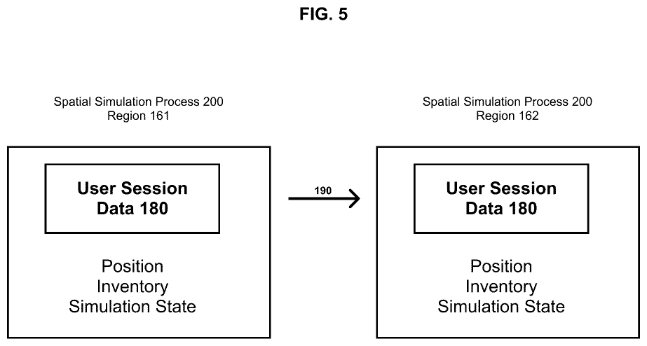

User sessions are represented by user session data structures 180 stored in memory and associated with active spatial simulation processes 200, as illustrated in FIG. 5. Migration of a user session between spatial simulation processes may occur through a migration event 190 transferring the user session data structure 180 from a source spatial simulation process to a destination spatial simulation process.

Each user session data structure may include a unique user identifier, authentication credentials, team or group association, score or ranking information, inventory or asset data, session duration metrics, contextual state variables, and other persistent state data.

Migration between spatial regions involves transferring execution state of the user session data structure from a source spatial simulation process to a destination spatial simulation process.

Migration may be triggered by detection of a user crossing a boundary, entry into a designated transfer zone, portal interaction, trigger volume detection, system-initiated migration events, or forced migration conditions.

The migration controller 140 coordinates operations including serialization of user session data structures 180, transmission of serialized state to the destination computational instance 110, reconstruction of the user session state within the destination spatial simulation process 200, and termination of the user session state within the source spatial simulation process.

Persistent state is preserved during migration, ensuring logical continuity of the multiplayer environment.

In certain embodiments, precise spatial coordinates need not be preserved. The destination region may define spawn locations or insertion points.

### 8. Contraction Operation

When one or more contraction conditions are satisfied, the topology controller performs contraction operations.

Contraction may include identifying one or more spatial regions for decommissioning, updating the topology data structure to mark selected nodes as decommissioning, restricting inbound migration to selected regions, migrating user sessions out of selected regions, removing nodes from the topology data structure, and terminating corresponding spatial simulation processes.

Regions selected for decommissioning may include outermost regions having at least one boundary not connected to another active region, most recently instantiated regions, regions meeting defined population or utilization criteria, regions selected based on graph distance metrics, and regions selected via rule-based or algorithmic prioritization.

Multiple regions may be designated for decommissioning within a single contraction event.

Selected regions may be non-adjacent within the topology graph.

Removal of multiple non-adjacent nodes modifies the graph structure by eliminating multiple independent connectivity branches simultaneously.

### 9. Forced Boundary Embodiment

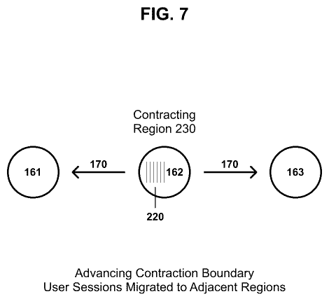

In certain embodiments, contraction may involve advancing a contraction boundary 220 within a spatial region 162 designated as a contracting region 230, as illustrated in FIG. 7.

The advancing boundary may represent a simulated environmental constraint, a closing region perimeter, a dynamically shrinking playable area, or a zone exclusion mechanism.

When a user session encounters the advancing boundary, migration is triggered to an adjacent region.

The boundary may continue advancing until the region is vacated, population falls below a threshold, or all user sessions are migrated.

This forced migration mechanism is optional and represents one embodiment of contraction enforcement.

The invention does not require forced migration for contraction to occur.

### 10. Dynamic Topology Representation

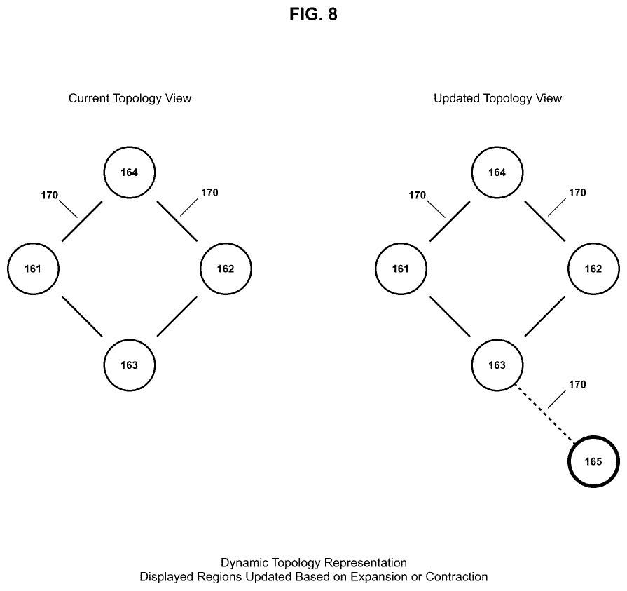

In certain embodiments, the system generates a topology representation reflecting the currently active spatial regions 161-166 and connectivity relationships 170, as illustrated in FIG. 8.

The representation may display nodes representing active regions, display edges representing connectivity pathways, indicate gated or unavailable regions, update dynamically upon expansion or contraction, and reflect current world extent.

The topology representation may be presented as a minimap, rendered as an abstract graph, displayed as a navigational interface, or integrated into a user interface layer.

This representation reflects real-time modification of the topology data structure.

### 11. Technical Improvement in Distributed Systems

The present invention improves distributed computing systems by dynamically modifying a topology data structure in memory that governs connectivity among executing spatial simulation processes.

Conventional server sharding replicates static instances without altering the structural topology of the virtual environment.

The disclosed system dynamically adds nodes to a graph in memory, dynamically removes nodes from a graph in memory, dynamically updates edges to reflect current connectivity, transfers execution state between distributed simulation processes, improves compute utilization by eliminating idle static shards, prevents overloading individual simulation processes, reduces fragmentation of user populations, and maintains persistent shared world continuity.

These improvements are technical in nature and modify machine-level operations within distributed computing infrastructure.

### 12. Alternative Embodiments

The invention may be implemented in various embodiments including cloud-based distributed systems, on-premises distributed server clusters, hybrid distributed architectures, containerized orchestration environments, virtual machine-based deployment systems, and edge-distributed computing systems.

The topology data structure may be centralized in a master orchestration node, distributed across computational instances, replicated with consensus protocols, stored in volatile or non-volatile memory, or implemented as adjacency lists, adjacency matrices, or other graph representations.

Operational metrics may be determined via direct measurement, predictive modeling, machine learning models, historical trend analysis, or load balancing heuristics.

The invention is not limited to any particular implementation technology.

### 13. Multi-Region Batch Expansion

In certain embodiments, expansion may involve instantiating multiple spatial regions during a single expansion operation.

Batch expansion may occur when operational metrics exceed expansion thresholds by a significant margin, rapid user growth is detected, or predictive models anticipate imminent load increase.

During batch expansion, multiple new nodes are added to the topology data structure, corresponding spatial simulation processes are instantiated, edges are created between newly instantiated regions and one or more existing regions, and connectivity relationships may form branching or mesh-like graph extensions.

Batch expansion may connect new regions to a single existing region, multiple adjacent existing regions, or distinct portions of the graph simultaneously.

### 14. Multi-Region Batch Contraction

In certain embodiments, contraction may involve decommissioning multiple spatial regions during a single contraction event.

Batch contraction may occur when operational metrics fall substantially below defined thresholds, system load drops rapidly, or resource conservation is required.

Multiple regions selected for contraction may be adjacent, non-adjacent, located on different branches of the topology graph, selected based on graph distance metrics, or selected based on instantiation order.

Batch contraction modifies the topology data structure by removing multiple nodes and associated edges.

This allows rapid topology reduction without requiring sequential inward collapse from a single direction.

### 15. Failure Handling and Redundancy

The system may include failure handling mechanisms.

If a computational instance fails unexpectedly, the corresponding node may be marked inactive, the topology data structure may be updated to remove or disable edges, user sessions may be migrated to alternate regions, and replacement regions may be instantiated automatically.

Redundant topology data structures may be maintained to ensure consistency across distributed orchestration components.

Consensus mechanisms or synchronization protocols may maintain graph integrity across distributed memory stores.

### 16. Recovery and Reinstatement

If operational metrics increase following contraction, previously removed regions may be reinstantiated, new regions may be instantiated in different topological positions, and the topology graph may be reconstructed dynamically.

Expansion following contraction is not limited to restoring previously removed nodes in identical positions.

Topology evolution over time may produce different graph configurations depending on runtime conditions.

### 17. Method Embodiment

In addition to system embodiments, the invention includes method embodiments for dynamically reconfiguring spatial topology in a persistent multiplayer environment.

A method may comprise executing spatial simulation processes across distributed computational instances, monitoring operational metrics, evaluating expansion and contraction conditions, modifying a topology data structure stored in memory, instantiating additional spatial simulation processes in response to expansion conditions, designating spatial simulation processes for termination in response to contraction conditions, migrating user session data structures between simulation processes, preserving persistent user state across migrations, and updating connectivity relationships among spatial regions.

The method embodiment is not limited to any specific programming framework, network protocol, or deployment environment.

### 18. Additional Embodiment Variations

The invention may further include embodiments in which spatial regions are dynamically resized rather than instantiated, edges are weighted to represent latency or capacity, predictive scaling anticipates future load, region instantiation is geographically aware, graph traversal algorithms determine routing decisions, artificial intelligence models determine expansion timing, migration prioritization occurs based on user attributes, and regional merging operations combine two regions into one.

None of these embodiments limit the core inventive concept of dynamic topology reconfiguration governed by operational conditions.

1. A computer-implemented distributed system comprising:
a plurality of networked computational instances each executing a respective spatial simulation process representing a spatial region of a persistent multiplayer virtual environment;
a topology data structure stored in memory of the distributed computing system, the topology data structure comprising a graph including nodes representing spatial regions and edges representing connectivity relationships among the spatial regions;
at least one processor configured to monitor one or more operational metrics associated with execution of the spatial simulation processes and to modify the topology data structure in memory during runtime in response to the one or more operational metrics, including (i) adding one or more nodes to the topology data structure and instantiating corresponding spatial simulation processes on additional computational instances in response to at least one expansion condition, and (ii) removing one or more nodes from the topology data structure and designating corresponding spatial simulation processes for termination in response to at least one contraction condition;
and a migration controller configured to transfer execution state of user session data structures between spatial simulation processes according to connectivity relationships defined by the topology data structure while preserving persistent user state;
wherein modification of the topology data structure dynamically reconfigures the graph structure to modify connectivity among executing spatial simulation processes to improve distributed resource utilization and machine-level execution of spatial simulation processes while maintaining logical continuity of the persistent multiplayer virtual environment.

2. A computer-implemented method for dynamically modifying a spatial topology of a persistent multiplayer virtual environment, comprising:
executing a plurality of spatial simulation processes across a plurality of distributed computational instances;
maintaining in memory a topology data structure comprising a graph including nodes representing spatial regions and edges representing connectivity relationships among the spatial regions;
monitoring one or more operational metrics associated with the persistent multiplayer virtual environment;
modifying the topology data structure by adding one or more nodes and instantiating corresponding spatial simulation processes in response to at least one expansion condition;
modifying the topology data structure by removing one or more nodes and designating corresponding spatial simulation processes for termination in response to at least one contraction condition;
migrating user session data structures between spatial simulation processes according to the connectivity relationships defined by the topology data structure;
and preserving persistent user state across migrations to maintain logical continuity of the persistent multiplayer virtual environment.

3. A computer-implemented system for operating a persistent multiplayer virtual environment, comprising:
a plurality of computational instances each configured to execute a respective spatial simulation process representing a spatial region of the persistent multiplayer virtual environment;
at least one processor configured to determine a global active user population across the plurality of spatial regions;
a topology controller configured to instantiate at least one additional spatial region when the global active user population exceeds a first population threshold and to designate at least one spatial region for decommissioning when the global active user population falls below a second population threshold;
a migration controller configured to migrate user sessions between spatial regions while preserving persistent user state;
wherein instantiation and decommissioning dynamically modify a spatial extent of the persistent multiplayer virtual environment while maintaining a logically continuous shared world.

4. The system of claim 1, wherein the operational metrics comprise at least one of active user population, user density, compute utilization, memory usage, network latency, throughput, or engagement metrics.

5. The system of claim 1, wherein each spatial region is associated with a capacity threshold and inbound migration is restricted when the capacity threshold is satisfied.

6. The system of claim 5, wherein inbound migration is permitted when a population of the spatial region falls below the capacity threshold.

7. The system of claim 1, further comprising a routing controller configured to route newly joining user sessions to a least-loaded spatial region.

8. The system of claim 1, wherein instantiating the one or more additional spatial regions comprises connecting a newly instantiated spatial region to multiple existing spatial regions.

9. The system of claim 1, wherein the one or more spatial regions designated for termination include non-adjacent regions within the topology data structure.

10. The system of claim 1, wherein decommissioning comprises selecting at least one spatial region located at a boundary of the topology data structure.

11. The system of claim 1, wherein decommissioning comprises selecting at least one most recently instantiated spatial region.

12. The system of claim 1, wherein migration is triggered by detection of a user session crossing a boundary associated with a spatial region.

13. The system of claim 12, wherein the boundary comprises a transfer zone defined within the persistent multiplayer virtual environment.

14. The system of claim 1, wherein decommissioning further comprises advancing a boundary within a spatial region to induce migration of user sessions to adjacent regions.

15. The system of claim 1, wherein persistent user state comprises at least one of identity, team membership, score, survival duration, inventory, or global ranking.

16. The system of claim 1, further comprising generating a dynamic topology representation reflecting currently active spatial regions.

17. The system of claim 16, wherein the dynamic topology representation updates in response to addition or removal of nodes within the topology data structure.

18. The method of claim 2, wherein removing one or more nodes comprises removing multiple non-adjacent nodes during a single contraction operation.

19. The method of claim 2, wherein adding one or more nodes comprises adding multiple nodes during a single expansion operation.

20. The method of claim 2, wherein migration preserves multiplayer session continuity across distributed computational instances.

21. A non-transitory computer-readable medium storing instructions that, when executed by one or more processors of a distributed computing system, cause the distributed computing system to:
execute a plurality of spatial simulation processes across a plurality of distributed computational instances;
maintain in memory a topology data structure comprising a graph including nodes representing spatial regions and edges representing connectivity relationships among the spatial regions;
monitor one or more operational metrics associated with a persistent multiplayer virtual environment;
modify the topology data structure by instantiating additional spatial regions or designating spatial regions for termination in response to the operational metrics; and
migrate user session state between spatial simulation processes while preserving persistent user state.

22. The system of claim 1, wherein the topology data structure comprises a dynamically reconfigurable graph structure in which nodes represent spatial regions and edges represent migration pathways between spatial regions.

23. The system of claim 1, wherein the topology controller is configured to determine a target spatial region for routing a user session based on at least one of spatial region population, computational resource utilization, network latency, or geographic proximity.

24. The system of claim 1, wherein expansion of the topology data structure is triggered based on predictive analysis of operational metrics indicating an anticipated increase in user population or computational load.
